(19) United States
(12) Patent Application Publication
(10) Pub. No.: US 2011/0082816 A1
(43) Pub. Date: Apr. 7, 2011

(54) SYSTEMS AND METHODS FOR OPTIMIZING VEHICLE TOWING

(76) Inventor: Jack Lee Moffett, Rudy, AR (US)

(21) Appl. No.: 12/862,809

(22) Filed: Aug. 25, 2010

Related U.S. Application Data
(60) Provisional application No. 61/247,704, filed on Oct. 1, 2009.

(51) Int. Cl. G06F 17/00; G06Q 10/00

(52) U.S. Cl. 705/400; 705/7.11

(57) ABSTRACT

A web-based mapping, pricing, and profitability calculator for the automotive towing industry.

### RELATED APPLICATION

This application claims the benefit of and priority to U.S. Provisional Application No. 61/247,704 filed Oct. 1, 2009, the contents of which are herein incorporated by reference in their entirety for all purposes.

### FIELD OF THE INVENTION

The invention relates to systems and methods for optimizing the towing of vehicles in general, furthermore it relates to the improved apparatus, software, and systems for the interactive optimization of the dispatch of towing vehicles in particular.

### BACKGROUND

The scheduling and dispatching of towing vehicles is typically a manual process that relies on the cumulative experience of a dispatcher. In most situations, an individual who has a disabled vehicle will call a towing company dispatcher directly, or a call will be made by a third party that acts as an intermediary between the caller and the towing company dispatcher. The dispatcher will identify a group of towing vehicles that are available, estimate the distance between the available towing vehicles and the broken vehicles, determine which towing vehicle is available, and then call the available towing vehicle and dispatch it to the disabled vehicle location. The dispatcher will tell the towing vehicle driver where the disabled vehicle needs to be transported, for example, to a garage, wrecking yard, or an insurance adjuster's lot.

This manual method of determining the route to dispatch the towing vehicle may result in the dispatcher not considering a number of variables. For example, the dispatcher should consider if the operator of the towing vehicle is near the end of his or her working shift, the estimated time it can take to load the damaged vehicle onto the towing vehicle, the cost reimbursement of a particular insurance company for the towing distance, and whether where the destination is close to a rental car and/or hotel for the convenience of the owner of the damaged car.

Previous solutions to the problem of optimizing routes are well known. Route optimizing algorithms, such as the traveling salesman problem, are also well known. The route optimizing algorithms, when implemented may lead to a theoretically optimal solution, the amount of computational time would be enormous. Therefore, there is a need for a practical optimization algorithm for towing vehicle dispatching.

Some relevant prior art in the area of optimizing towing vehicle dispatch routes include the following. For example, U.S. Patent No. 6,604,081 issued on Aug. 5, 2003 to Manning, et.al., describes a method for analyzing the profitability of freight loads hauled by freight loaded vehicles. U.S. Patent Application Publication 2002065703 published on May 30, 2002 to Garg describes an application for tow management, but does not describe optimization for the dispatch of a particular tow. U.S. Patent Application Publication 20060190317 published on Aug. 26, 2006 to Crockett, describes a tow claims management system, but does not describe a system for the optimization of towing.

The efficient and timely estimation of operating costs (e.g. profit or loss) and route optimization is an important criterion to the efficient operation of the system. One mechanism available for route optimization is to: 1) use a separate source for mapping/mileage/work time determination; 2) calculate the variable operating costs of the equipment (for example, tow-truck) to be used on the call; 3) calculate the operator's compensation; 4) multiply the time and/or distance variables by the associated costs; and 5) subtract those costs from the revenue that the call will generate to ascertain the operating profit or loss that results from doing the call.

Furthermore, as certain web technologies have become ubiquitous on mobile telephones, what is further needed is an intuitive web-based software application that can implement a practical towing vehicle dispatching algorithm that is based on mobile technologies that utilize internet/web interfaces.

Furthermore, mobile, interactive, web technologies now allow a towing vehicle driver to input pertinent operating parameters, as opposed to dispatching information verbally to an operator over the phone.

More importantly, previous solutions for tow-truck optimization do not allow for the display of interactive maps on mobile devices to the towing vehicle drivers in conjunction with the route optimization so that the operator can avoid certain real-time traffic bottlenecks as they attempt to complete their route.

### BRIEF DESCRIPTION OF THE INVENTION

The present invention overcomes problems in the prior art by optimizing the route scheduling for the towing industry in particular, and the dispatching of metered vehicle services in general. The invention allows a towing company to price and evaluate the feasibility of prospective tow calls based on the profitability of the call, as determined by the company's marginal operating cost of providing the service for that particular call.

These and other embodiments are described in more detail in the following detailed descriptions and the figures. To date, the only way to gain the same information on a call by call basis is to use a separate source of mapping/mileage/work time determination and a calculator to determine the variable operating cost of the equipment (truck) to be used on the call, calculate the operator's compensation, multiply the time and/or distance variables by the associated costs, and then to subtract those costs from the revenue that the call will generate to ascertain the operating profit or loss that results from doing the call. This method has severe shortcomings as it takes far too long to do on every call, and it's not practical to attempt in the timeframe that you typically have the customer on the phone. The present invention performs the entire process very quickly. The user simply needs to enter the address of the locations where the vehicle to be towed will be loaded and unloaded and the program automatically determines the mileage and time requirements for performing the service. There are options that allow the user to change equipment, operators, add surcharges, manually change the mileage or time requirements, account for variations in the cost of fuel, change the fee parameters, and easily change sales tax rates for tows that will be done out of area. Once the desired options are selected, the user can select one of multiple pricing methodologies based on the profitability of each methodology. This can all be done within the time that the user has a customer on the telephone. There is nothing on the market that performs the same array of functions (mapping, pricing, and profitability evaluation). The one element that most distinguishes the invention, though, is the ability to select a desired profit margin and letting the program back into a price that achieves that margin, rather than using trial and error to calculate a price that meets the desired profit margin.

The foregoing is not intended to be an exhaustive list of embodiments. Persons skilled in the art are capable of appreciating other embodiments and features from the following detailed description in conjunction with the drawings.

### BRIEF DESCRIPTION OF THE DRAWINGS

FIG. 1 depicts the home page of an embodiment of the invention.

FIG. 2 depicts an options form displayed on the website.

FIG. 3 depicts an expenses form displayed on the website.

FIG. 4 depicts an operating profit form.

FIG. 5 is a flowchart for calculating the total miles.

FIG. 6 is a flowchart for calculating the total travel time.

FIG. 7 is a flowchart to the calculation of travel time.

FIG. 8 is a flowchart for calculating the cost of an operator call.

FIG. 9 is a flowchart for the pricing method.

FIG. 10 is a spreadsheet embodiment.

### DETAILED DESCRIPTION OF THE INVENTION

The invention encompasses a methods for calculating the cost of a tow call, and for calculating the profit margin and the fee charged to the customer. The invention additionally includes a system for carrying out the method. Additionally the invention encompasses systems and methods for calculating the contribution margin of the tow, event revenue, and marginal profit percentage.

The contribution margin of the tow is the remainder of the event revenue that is left available to be applied to a company's overhead and profit once the direct costs of performing the tow are deducted. The marginal profit percentage is the contribution margin divided by the event revenue, displayed as a percentage. The event revenue is the total revenue generated by a towing event.

In general the sequence of steps required to perform the invention is as follows.

A customer calls to indicate they need a tow truck to tow their vehicle from Point A to Point B. Alternatively, the customer's request could be for a roadside service call (jumping a dead battery, delivering fuel if they have ran out, unlocking their car if they locked in the keys, or changing their flat tire), which involves resolving the customer's issue without towing the vehicle.

The logistics of the call are calculated by utilizing a mapping program (Google Maps, Mapquest, etc). If the call is a tow call, it includes mileage to the vehicle from Point A to Point B, and mileage to return the tow truck back to the home base (Point C). If it's a service call, it omits the mileage that the vehicle will be towed, so it is simply the mileage to the vehicle and the return mileage back to the home base location. Depending on the method of pricing for the event, the logistics may also include the length of time necessary to perform the event.

The two most typical methods of pricing towing events is Hookup Plus Mileage (a fee to load or hookup the vehicle plus a per mile fee for all or part of the mileage that will be incurred in getting to and towing the vehicle) or Hourly, which is the time required to perform the event multiplied by an hourly rate. Roadside service calls are typically a service fee plus a mileage fee for mileage incurred en route to the vehicle.

The round trip mileage to perform the towing or service event is multiplied by the variable operating cost per mile of the vehicle that will be used to perform the event. The variable operating cost per mile reflects only the costs that are incurred while the vehicle is actually being utilized for the event. It generally includes:

Fuel, Oil/lube, Tires, Brakes, Miscellaneous maintenance, Depreciation (the value of the vehicle goes down as the mileage goes up) and optionally insurance cost.

The compensation of the operator is calculated, since this is also a variable cost of performing an event. The two most typical methods of operator compensation are hourly and commission. The hourly method is self-explanatory. A commission operator's compensation is usually a percentage of the total fee charged to the customer for performing the event, although it may be a set fee.

Based on entering the logistics, the program now has the information required to calculate the contribution margin of the event. The revenue generated by the event is determined by the pricing method. The variable operating cost is determined by the total mileage of the event multiplied by the variable operating cost per mile of the truck used to perform the event, plus the operator compensation. Deducting the variable operating cost from the revenue yields the contribution margin. The contribution margin divided into the event revenue generates a contribution margin ratio, which is a marginal profit percentage derived from performing the event.

A basic embodiment the invention is a method for calculating the cost of a tow (or a system for carrying out this method). The method comprises the following steps:

1. Customer calls tow truck operator.

2. The following input data is provided by operator (*=optional):
Truck location (L1)
Car location (L2)
Garage (L3)
Truck home (L4)
Work time at site (Tw)*
Cost of work per house at site (Cw)*
Cost of operation of truck per mile (Ct)
Hookup fee (Ch)*
Cost (pay) of driver (Cd) [may be hourly or on commission]

3. Operator calculates round trip (total) mileage (D) using mapping software

4. Operator calculates total cost of tow (X); X=(D×Ct)+Cd+Ch+(Cw×Tw)

5. Operator determines the fee charged to client (F)

6. Operator calculates profit (P) P=F−X

Additionally the operator may calculate
the contribution margin of the tow
event revenue
marginal profit percentage.

The method above may be performed using a computer programmed with a computer program wherein data is entered and displayed via a graphical user interface (GUI) displayed on a screen. The computer may be of any type including hand held. The program may be resident on the computer or on the internet.

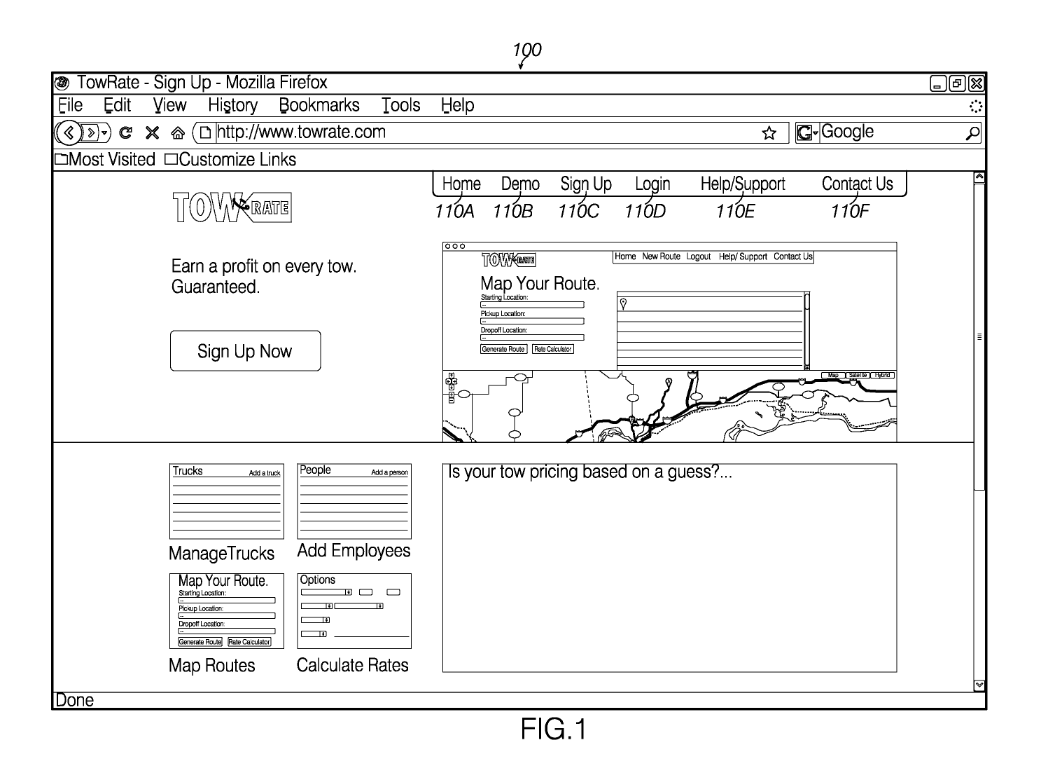

Representative embodiments of GUIs are shown in FIGS. 1-10 wherein similar features share common reference numerals.

Other useful embodiments include the following:

A computer based system for displaying components and processes associated with providing an operating profit margin to a user, comprising a display, a memory, a central processor and a user interface, the display further comprising at least one graphical user interface (GUI), the GUI comprising a plurality of input fields, wherein an input field has an identifier selected from the group consisting of revenue, expenses, operating profit, rate, equipment, operator, mileage, price, call type, and desired profit, the GUI further comprising at least one output field, and wherein the user enters data into the input field using the interface.

The computer based system described above, wherein the identifier is further selected from the group consisting of travel time and idle time.

The computer based system described above, wherein the rate is a tow rate.

The computer based system described above, wherein the price is a tow price.

The computer based system described above, wherein the display comprising at least one GUI, the GUI is selected from the group consisting of a homepage GUI, a dispatch screen GUI, an options GUI, an expenses GUI, and a profit margin GUI.

The computer based system described above, wherein the memory comprises a computer program for calculating the operating profit margin.

The computer based system described above, wherein the central processor calculates the operating profit margin.

The computer based system described above, wherein the data is selected from the group consisting of hookup, mileage, hourly, max method, equipment, information, equipment information, fuel, cost, fuel cost, idle, load, unload, minutes, idle minutes, load minutes, unload minutes, mph, average, and average mph, or any combination thereof.

The computer based system described above, wherein the output field has an identifier selected from the group consisting of profit, profit margin, operating profit, and operating profit margin, operator, cost, operator commission, total minutes, and total travel time.

The computer based system described above, wherein the user interface is selected from the group consisting of a keyboard, a touch-screen, a voice-recognition device, and an entry pad.

The computer based system described above wherein, in use, the field identified by “profit” displays an operating profit or loss.

A preferred embodiment uses a web-based program to calculate the cost of the tow and perform other functions of the method of the invention.

FIG. 1 is a screen-shot of the “home page” (100) of an embodiment that uses a web-based “tow-rate” application hosted on an internet server. The application consists of a number of process selection tabs, 110A-F that allow the user to access the “home page” (110A) (shown) of the tow-rate application, a demonstration page (110B) (demo page), a sign up page (110C), a login page (110D), and a contact page (110E). The home page and contact page are provided for support purposes and aid the user in contacting the vendor.

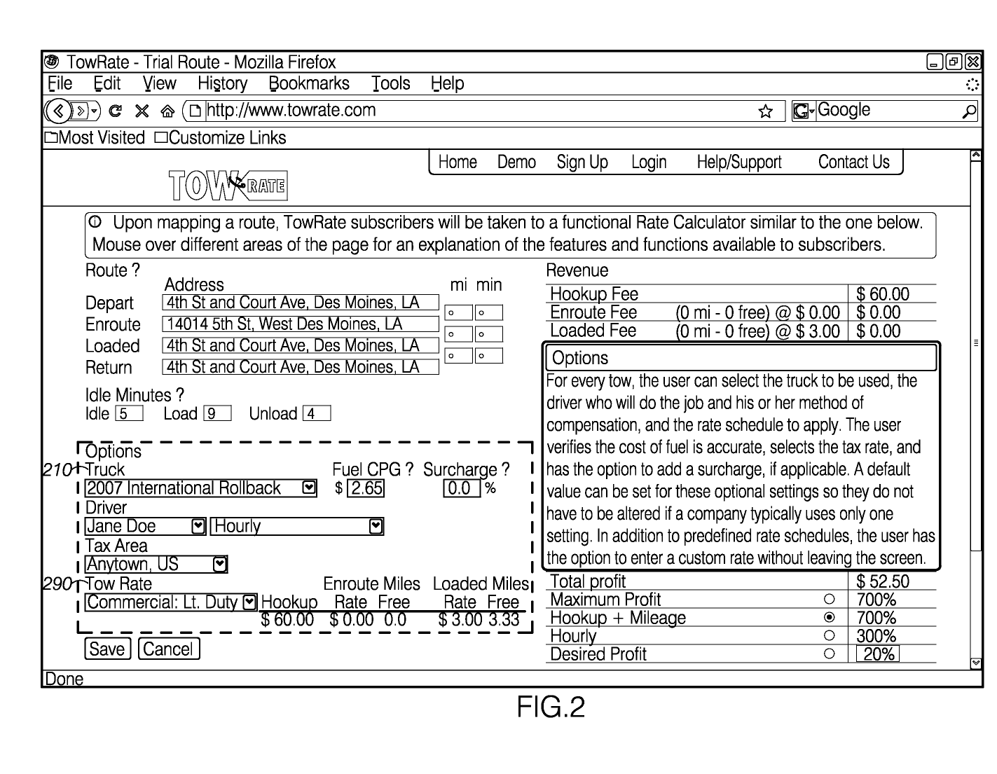

FIG. 2 is a screen-shot that illustrates a web page interface with fields are provided for entering route information. These fields include fields for route information (departure location, destination location, loaded information, truck information, driver information etc. The loaded information includes the time and distance variables for when the tow truck is loaded with a vehicle, so this is the route logistics between the pickup location (enroute) and the dropoff location. Below this are a group of fields for entering optional information, including, but not limited to, the type of truck performing the tow, the fuel used and the surcharge, the time and date of the towing activity and the rate specific to this towing activity. Other fields show the revenue calculated for the data that is entered into the fields on the right hand column.

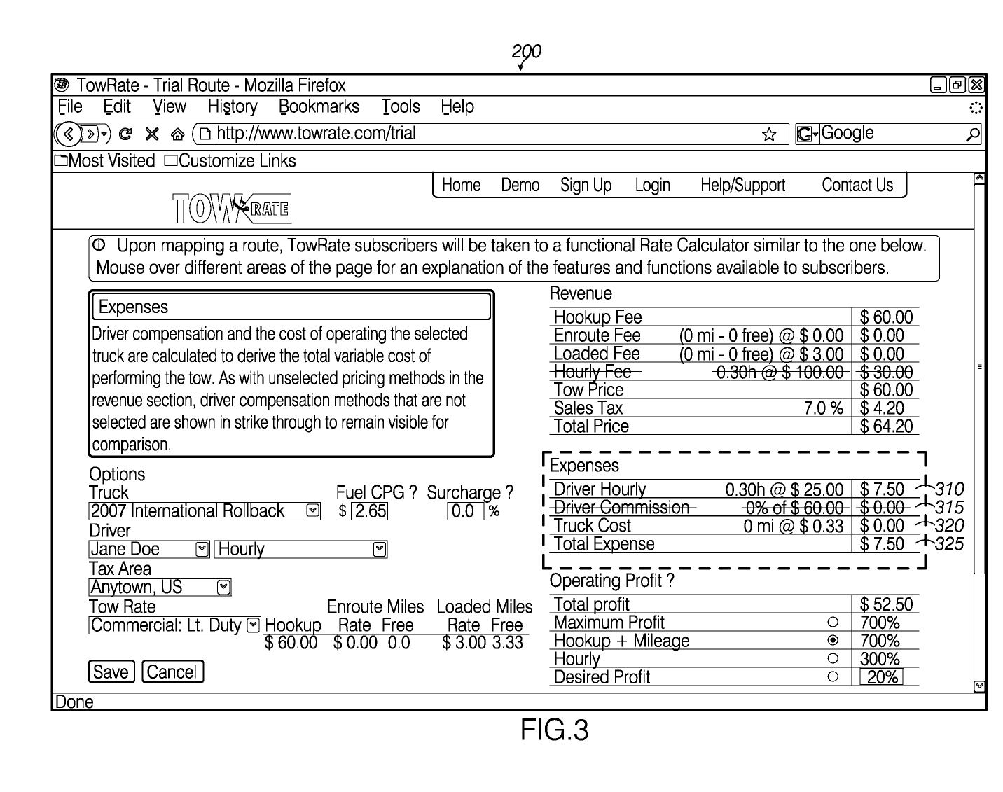

FIG. 3 is a screen-shot that depicts the same screen as shown in FIG. 2, but the field on the lower right hand side of the screen was masked in FIG. 2. The expenses are calculated from the data input on the left hand side of the screen. These fields include the drivers' hourly compensation 310, the drivers' commission (struck out) 315, the variable truck cost 320, and the total expenses of the tow 325. Below this field the operating profit is calculated and displayed.

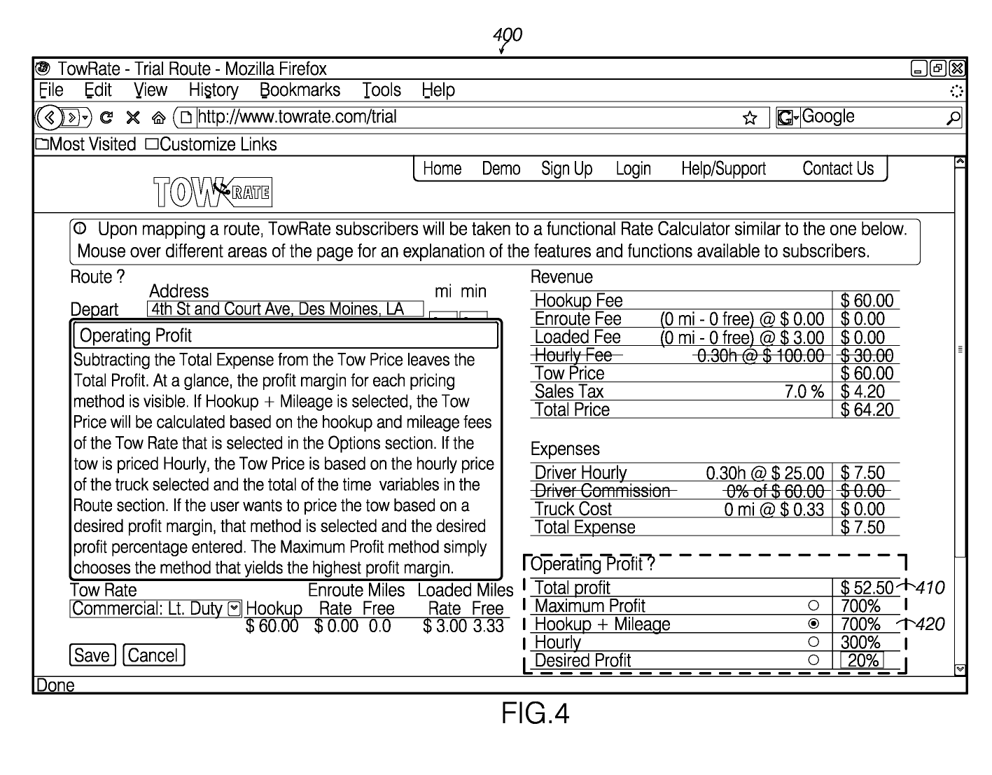

FIG. 4 is a screen-shot that depicts the total operating profit deployment page 400. The total operating profit 410 consists of subtracting the total tow expense 420 from the price of the tow (as previously calculated). The tow price is calculated from the hook up and mileage fees of the towing rate that is selected. For example, if the tow is priced hourly, the tow price is based on the hourly price of the truck selected and the total cost of the time variables in the Route section.

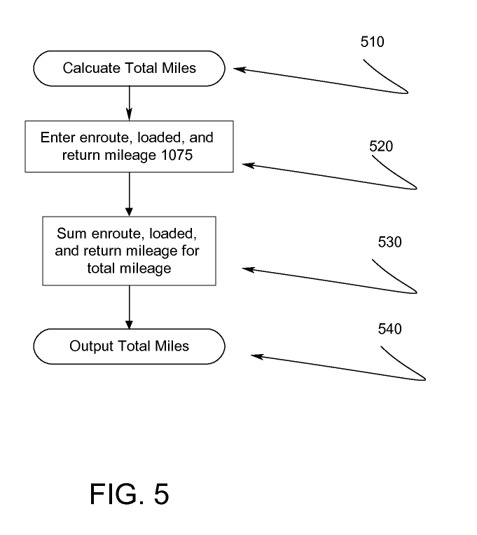

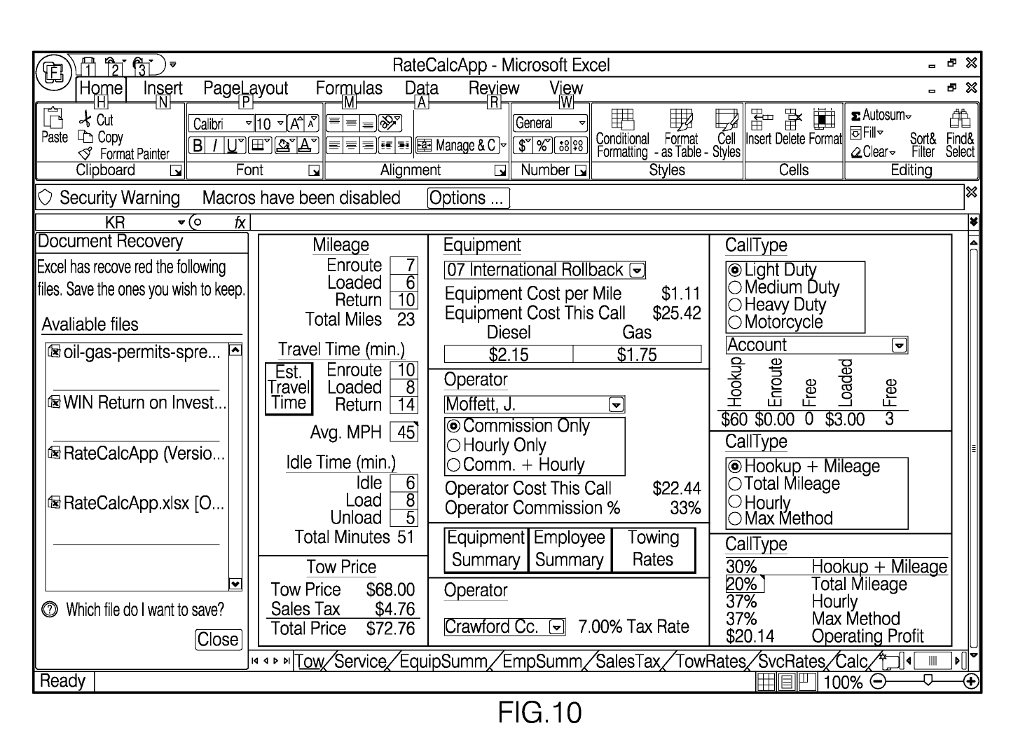

FIG. 5 is a screen-shot that depicts a flowchart of the calculations made by a spreadsheet as shown on FIG. 10. As illustrated on FIG. 5, the total miles for the towing operation are calculated 510 by entering the enroute, loaded, and return mileage 520 is entered, resulting in a calculated total miles 530, which is output 540.

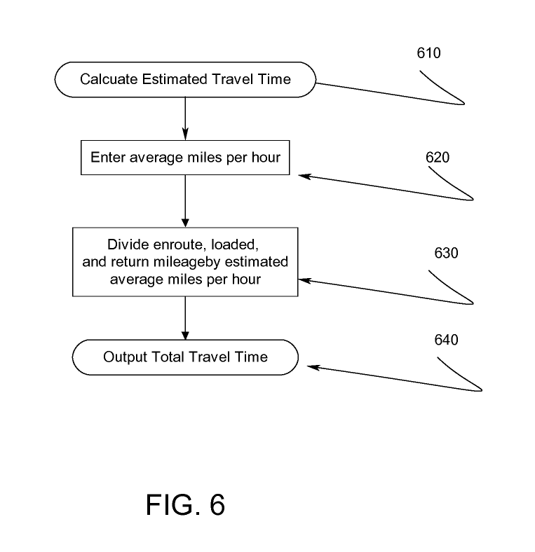

FIG. 6 is a flowchart of the calculations made by a spreadsheet as shown on FIG. 10. As illustrated on FIG. 6, the average miles per hour for the towing operation is input 620. The average travel time for the enroute, loaded, and return miles are calculated 630, in which the total average travel time minutes 640 may be calculated.

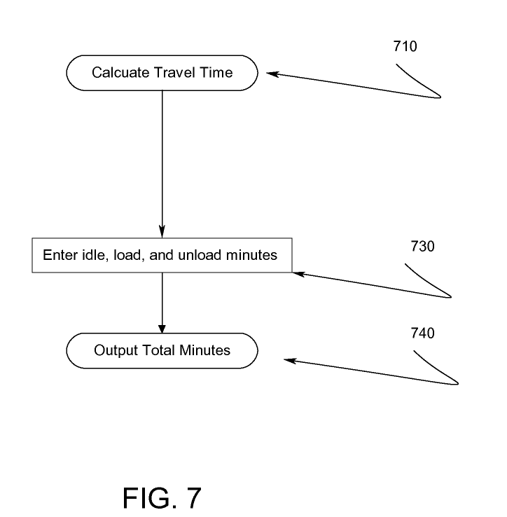

FIG. 7 is a flowchart of the calculations made by a spreadsheet as shown on FIG. 10. As illustrated on FIG. 7, the total minutes the towing vehicle will be operating 740 is the sum of the travel time minutes and the idle, load, and unload minutes 730.

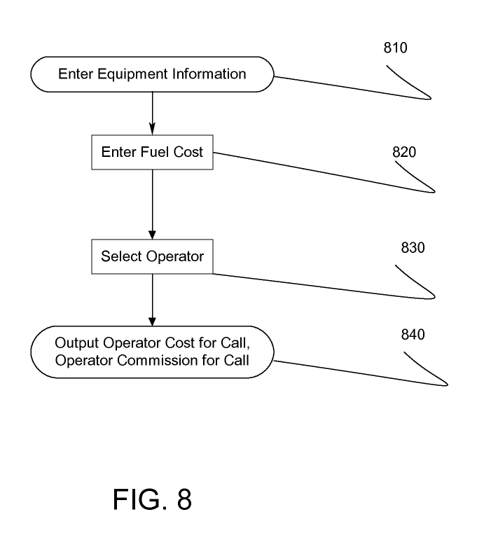

FIG. 8 is a flowchart of the calculations made by a spreadsheet as shown on FIG. 10. As illustrated on FIG. 8, the equipment information 810 for the towing vehicle is selected from a pull down list. Representative examples of the type of equipment information 810 are, for example, but not limited to various forms of tow truck and recovery equipment. The fuel cost 820 is entered for gasoline or diesel. The operator 830 of the towing vehicle is selected from a pull down list. The operator 830 is designated as commission only, hourly only, and commission with hourly.

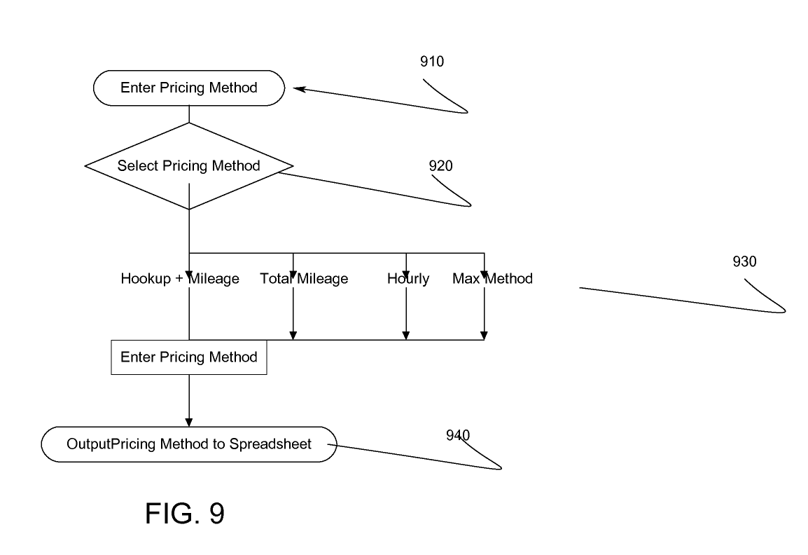

FIG. 9 that shows pricing methodologies as applied to the tow cost. A pricing method is selected 910, 920 from list of options 930 (Hookup and Mileage, Total Mileage, Hourly, and Max Method). The pricing method is then output to a spreadsheet.

FIG. 10 is a screen-shot that depicts the graphical user interface (GUI) for the optimizer program (the program accessed by clicking the Rate Calculator button on the mapping page) comprising at least the following fields and functions: Calculation of total miles, enroute miles, and return miles; Calculation of Travel Time (mins.); Average speed (MPH); Idle time; and Tow price. It also lists a section for equipment type, equipment cost per mile, and equipment cost for the present call. It also includes fields for operator name and whether the operator is on an hourly rate or commission. It also includes fields for fuel call type (light, medium, heavy or motorcycle) and for call type, i.e., hookup plus mileage etc.

The user may adjust these input parameters to estimate cost based on a desired profit margin. As such the program allows the user to optimize the desire profit margin by modifying the input parameters.

Various embodiments of the invention include a map routing program that displays the route on a web page. For example, the dispatch operator or towing vehicle driver may enter the starting location of the towing vehicle, the pickup location where to towing vehicle is dispatched to, (for example, where the disabled vehicle is located, and the dropoff location of the disabled vehicle (for example, to where the disabled vehicle will be taken).

This web based software provides an interactive route map for the towing vehicle operator and/or dispatcher. The screenshot of FIG. 10 may use a commercial spreadsheet application. In use, the enroute, loaded, and return mileage is entered, resulting in a calculated total miles. Also entered is the idle time during a particular towing operation. The equipment is selected and the selection of a particular type of equipment will determine the equipment cost per mile and total equipment cost for this call.

The operator can also set fuel costs, such as for unleaded or diesel fuel. The operator may also be selected. The operator can be set as a commissioned driver, an hourly only driver, and/or a mix of commissioned and hourly. On the right hand top of the spreadsheet is a field for implementing the call type. For example the user can select if the call type 1005 is light duty, medium duty, heavy duty, and/or a motorcycle. Those skilled in the arts are able to classify the type of call based on their understanding of the vehicle, the parameters of the call, and/or the accident.

The call type can also be segregated as to whether it is a call on an account, a call for an insurance company, and/or any type of third party. The pricing method can be selected as hookup plus mileage, total mileage, hourly, and the maximum method. The spreadsheet calculates operating profit. This operating profit 1025 shows the allocation between total mileage, hourly, maximum method, and final calculated operating profit. These output values are calculated in the spreadsheet by the use of internal formulas and macros. Although a spreadsheet program has been used as an illustrative embodiment, any type of program can be used that performs the equivalent functionality.

The web based program for the management of towing vehicle operations requires certain maintenance functions that are not essential to the utilization of the inventive subject matter, but, are necessary for the proper operation and maintenance of a web based software program. One such database that needs to be utilized and maintained is information on the towing vehicle driver. In the preferred embodiment a web page is used for entering information on the towing vehicle driver. In this web page the towing vehicle driver will enter all pertinent information, such as the name of the driver, the hourly rate and/or fixed rate the towing vehicle driver will make. Additional relevant fields include the type of vehicle operated and any associated costs and/or special characteristics (for example, will tow particular cars, such as exotic or oversized vehicles) may also be entered into this screen. This screen may be configured for a single operator/driver or it may be configured for a company that supplies a fleet of towing vehicle drivers.

Another such internal database that needs to be utilized and maintained is information on information on the subscriber. The present inventive subject matter would also include a payment and subscription renewal web page that would allow entry of information to facilitate the billing of the customer that is using the application.

Another such internal database that needs to be utilized and maintained is information on technical support inquiries. The application would provide an entry form allowing the support of user calls regarding the application.

### METHODS FOR USING THE INVENTION

The invention includes methods for using the web based embodiment or the spreadsheet embodiment (collectively “optimization program”). The dispatch operator receives a call from a disabled vehicle. The dispatch operator then enters the location of the disabled vehicle into the program. The operator then selects which vehicle to dispatch to optimize time, operating profit, etc. For example, the operator may want to optimize operating profit if the tow is not time constrained. Alternately, the operator may want to optimize time if the vehicle is in a hazardous location and/or blocking traffic during rush hour.

In certain embodiments the dispatcher's goal is to optimize profit margin. As profit margin can be best evaluated based on information presented (for example, mapping, pricing, and profitability evaluation) the ability to select the profit margin as the primary factor will increase overall profits for the company.

The term “user” shall refer to an end-user of the described application and shall not be limited to a particular class of users. Users may be towing vehicle drivers, drivers whose vehicles are inoperable, dispatch operators, and third party operators, such as insurance companies. A user may also refer to another truck operation systems, such as a system engaging in the delivery of goods, product, supplies, equipment, services, people and the like.

Those skilled in the arts can determine the underlying components used to construct a software program that executes the preferred embodiment. For example, the software program may operate using such programs as Python, PERL, and/or C and use commercially available web server platforms. The storage of the required information may be done with such programs as mySQL, ACCESS and other database programs that are well known in the arts. Information may be organized in a relational, hierarchical, and/or object-oriented manner. Persons skilled in the art will recognize that many modifications and variations are possible in the details, materials, and arrangements of the parts and actions which have been described and illustrated in order to explain the invention and that such modifications and variations do not depart from the spirit and scope of the teachings and claims contained therein.

All patent and non-patent literature cited herein is hereby incorporated by reference in its entirety for all purposes.

### DEFINITIONS

The term “towing vehicle” shall refer to any vehicle used to move a disabled vehicle. It is not limited to a particular class of vehicles, nor should it be construed that actual towing is involved. For example, the towing vehicle driver may simply provide fuel to an automobile that has run out of fuel or provide replacement mechanical and/or electrical parts, such as a windshield, a tire, or a battery.

The term “dispatch operator” or “dispatcher” shall generally refer to a person that is involved in the coordination and scheduling of the vehicles. The term should not be limited to an actual person, rather, the dispatch operator may be automated by a computer which allows for the pertinent information to be entered on forms (for example, a software input screen), by third parties, by drivers with inoperable vehicles, and/or towing vehicle drivers.

1. A system for calculating the total cost of a tow procedure (X) between at least three points, said system comprising (a) a computer functionally connected to the internet and loaded with and running a software program, and (b) an operator inputting information into the computer via a graphical user interface (GUI), wherein the GUI comprises a fill- in or drop-down field for each of the following elements:
Truck location (L1)
Car location (L2)
Garage location (L3)
Truck home (L4)
Work time at site (Tw)
Cost of work per house at site (Cw)
Cost of operation of truck per mile (Ct)
Hookup fee (Ch)
Cost of driver services (Cd) (may be hourly or on commission), and wherein the operator enters the relevant information into the corresponding fields using the GUI, and wherein the computer program calculates the total round trip mileage (D) using mapping software on the internet, and further calculates total cost of the tow procedure (X), where X=(D×Ct)+Cd+Ch+(Cw×Tw).

2. The system of claim 1 further comprising the step of the operator using X to select a fee charged to client (F).

3. The system of claim 2 further comprising the step of the operator calculating profit (P) where P=F−X.

4. The system of claim 2 wherein the GUI further comprises fields for: calculation of total miles, enroute miles, return miles and travel time.

5. The system of claim 2 wherein the GUI further comprises fields for: average speed and idle time.

6. The system of claim 2 wherein the GUI further comprises fields for: section for equipment type; equipment cost per mile, and equipment cost for the present call.

7. The system of claim 2 wherein the GUI further comprises fields for: operator name and whether the operator is on hourly or commission.

8. The system of claim 2 wherein the GUI further comprises fields for: call type including light, medium, heavy or motorcycle call types.

8. The system of claim 2 wherein the computer calculates, and the GUI further comprises fields for displaying the contribution margin of the tow, the revenue derived from the tow and the profit percentage.

9. The system of claim 2 wherein route information is entered by a spreadsheet.

10. The system of claim 2 wherein route information is entered by a web page.

11. The system of claim 2 wherein the GUI comprises separate fields for entering mileage information, equipment information, call type information, tow price information and operator information.

12. The system of claim 2 wherein the GUI is displayed on a hand held device.
